(19) United States
(12) Patent Application Publication
(10) Pub. No.: US 2016/0286932 A1
(43) Pub. Date: Oct. 6, 2016

(54) COSMETIC CONTAINER CAPABLE OF MIXING AND DISCHARGING TWO KINDS OF CONTENTS

(71) Applicant: PUM-TECH KOREA CO., LTD, Incheon (KR)

(72) Inventor: DO HOON LEE, Incheon (KR)

(21) Appl. No.: 14/778,284

(22) PCT Filed: Mar. 24, 2014
(86) PCT No.: PCT/KR2014/002440

§ 371 Date: Sep. 18, 2015

(30) Foreign Application Priority Data
Mar. 26, 2013 (KR) 20-2013-0002253

(51) Int. Cl. A45D 34/00; A45D 40/24; B05B 11/00; B65D 81/32

(52) U.S. Cl. CPC A45D 34/00; B65D 81/325; A45D 40/24; B05B 11/0043; B05B 11/3023; B05B 11/3084

(57) ABSTRACT

The present invention relates to a cosmetic container for mixing and discharging two types of cosmetic contents, and more particularly to a cosmetic container for mixing and discharging two types of cosmetic contents, that moves up the cosmetic contents stored in two storage containers provided in the cosmetic container through a single pumping operation, mixes the cosmetic contents with each other, and discharges the mixed cosmetic contents to the outside through a single discharge port. The cosmetic container for mixing heterogeneous contents, includes a container body (10) to receive a first storage container (11) and a second storage container (12) that separately store two types of cosmetic contents, a container receiving member (13) coupled to an inner peripheral portion of an opening of the container body (10) and coupled to outer peripheral portions of openings of the first and second storage containers (11 and 12), first and second tubular containers (15 and 16) securely mounted in the openings of the first and second storage containers (11 and 12) to receive a piston part (17), and a mixing member (30) provided at an upper end portion of the piston part (17) to mix the two types of cosmetic contents with each other. The mixing member (30) is provided therein with first and second discharge passages (31 and 32), through which the two types of cosmetic contents are transferred, and a single discharge passage (34) in which the two types of cosmetic contents axe mixed with each other, and provided at an upper portion thereof with a pressing button part (40) to press the mixing member (30) and to release the pressing to the mixing member (30).

### TECHNICAL FIELD

The present invention relates to a cosmetic container for mixing and discharging two types of cosmetic contents, and more particularly to a cosmetic container for mixing and discharging two types of cosmetic contents, capable of moving up the cosmetic contents stored in two storage containers provided in the cosmetic container through a single pumping operation, mixing the cosmetic contents with each other, and discharging the mixed cosmetic contents to the outside through a single discharge port.

### BACKGROUND ART

Generally, in the case of liquid-phase cosmetics, such as lotions, creams, gels, shampoos, and conditioners, or cosmetics in the state of a gel having low viscosity among cosmetics, an airless pump is received in a cosmetic container to easily discharge contents for use.

The cosmetic container to receive the cosmetics having the coefficient of viscosity is designed to allow a user to discharge and use a small amount of contents contained in the cosmetic container. In particular, the airless pump is mainly applied to a container to receive functional cosmetics.

In addition, the airless pump applied to the cosmetic container is used even in a cosmetic container for mixing heterogeneous contents, which mixes and discharges two types of contents having mutually different ingredients. In other words, functional cosmetics include the products of increasing the effects when contents having mutually different ingredients are mixed with each other and used, and the airless pump is mounted in a container for the functional cosmetics to discharge the contents thereof.

The conventional cosmetic container for mixing heterogeneous contents is disclosed in Korean Patent Registration No. 1037361. FIGS. 1 to 3 show a cosmetic container for mixing heterogeneous contents that mixes and discharges two contents having mutually different ingredient. A pair of storage containers 400 and 400′ to receive cosmetic contents are provided inside an outer container 300 provided on the bottom of the cosmetic container. The storage containers 400 and 400′ are provided at a lower portion thereof with lower pistons 411 and 411′ to move up whenever the cosmetic contents are consumed. Upper pistons are provided at openings of the storage containers 400 and 400′ to discharge the cosmetic contents. Piston rods 430 and 430′ are provided in the upper pistons to move down as a pair of buttons 200 and 200′ are pressed. Cosmetic discharge parts 120 and 120′ are provided to discharge contents pumped as the piston rods 430 and 430′ are moved up and down. The cosmetic discharge parts 120 and 120′ are coupled to a rubber tip 140 coupled to an inclined mixing part 110.

When the buttons 200 and 200′ are pressed, a connection member integrated with the buttons 200 and 200′ moves down the piston rods 440 and 430′. As the piston rods 430 and 430′ are moved down, check valves 451 and 451′ are open while the cosmetic contents stored in the storage containers 400 and 400′ are discharged to the mixing part 110 through the cosmetic discharge parts 120 and 120′.

However, as described above, the cosmetic contents transferred along paths of the cosmetic discharge pares 120 and 120′ are discharged into the mixing part 110 so that two types of cosmetic contents are mixed with each other for use. In this case, a user not only must mix two types of cosmetics with each other through the mixing part 110, but also clean the mixing part 110 after using the mixing part 110.

In addition, since the buttons 200 and 200′ separated from each other are used, the deviation between pressures applied to the buttons is made. Accordingly, the user may make up with the mixture of two types of cosmetic contents that are not mixed at a uniform ratio as the two types of cosmetic contents are not discharged in uniform amount.

In addition, since the cosmetic discharge parts 120 and 120′ are penetrated in a vertical direction, the cosmetic contents may be discharged at high pressure like a fountain and dropped down around the cosmetic container to be wasted.

### DISCLOSURE

### Technical Problem

The present invention is made to solve the above problems, and an object of the present invention is to provide mixing two types of cosmetic contents at an equal ratio by moving up the cosmetic contents received in a storage container through a single pumping operation and discharging the cosmetic contents through a single discharge passage provided in the storage container.

Another object of the present invention is to provide the convenience of the use as an additional mixing operation is not required differently from that of the related art since a mixing inducing member is provided in a discharge passage so that two cosmetic contents are mixed with each other while being discharged.

Still another object of the present invention is to produce an effect of preventing cosmetic contents from being wasted by minimizing the direct discharge of the cosmetic contents from a container when the cosmetic contents are discharged from the container as a mixing inducing member provided in a single discharge passage has pores, which lower the high pressure when the cosmetic contents are discharged, and are formed to the extent that the discharge path of the mixed cosmetic contents is not interrupted.

### Technical Solution

In order to accomplish the objects of the present invention, there is provided a cosmetic container for mixing heterogeneous contents. The cosmetic container includes a container body to receive a first storage container and a second storage container that separately store two types of cosmetic contents, a container receiving member undercut coupled to an inner peripheral portion of an opening of the container body and coupled to outer peripheral portions of openings of the first and second storage containers, first and second tubular containers securely mounted in a circular locking step of the opening of the first and second storage container to receive a pair of piston parts, and a mixing member provided at an upper end portion of the paired piston parts to mix the two types of cosmetic contents with each other. The mixing member is provided therein with first and second discharge passages, through which the two types of cosmetic contents are transferred, and a single discharge passage in which the two types of cosmetic contents are mixed with each other, and provided at an upper portion thereof with a pressing button part to press the mixing member and to release the pressing to the mixing member.

### Advantageous Effects

As described above, according to the present invention, the two types of cosmetic contents are mixed with each other at an equal ratio for makeup by moving up the two types of the cosmetic contents received in the storage container through the single pumping operation and discharging the cosmetic contents through the single discharge passage provided in the storage container. Since the two types of cosmetic contents are mixed through the single discharge passage provided in the storage container, the inconveniences of mixing cosmetic contents through a mixing part provided in the outside as disclosed in the related art and cleaning the mixing part after using the mixing part can be resolved.

In addition, as the mixing inducing member provided in the single discharge passage has pores, which lower the high pressure when the cosmetic contents are discharged, and are formed to the extent that the discharge path of the mixed cosmetic contents is not interrupted, the cosmetic contents can be prevented from being wasted, and the discharge port of the cosmetic container and the periphery thereof can be maintained in a clean state by minimizing the direct discharge of the cosmetic contents from the container when the cosmetic contents are discharged from the container.

### DESCRIPTION OF DRAWINGS

FIGS. 1 to 3 are side sectional views and a perspective view showing a cosmetic container for mixing heterogeneous contents according to the related art.

FIG. 4 is an exploded perspective view showing a cosmetic container for mixing heterogeneous contents according to the present invention.

FIG. 5 is a front sectional view showing the cosmetic container for mixing the heterogeneous contents according to the present invention.

FIGS. 6 to 7 are a front sectional view and a side sectional view showing the operating status of the present invention.

FIG. 8 is a side sectional view showing the state that first and second storage containers according to the present invention are contracted.

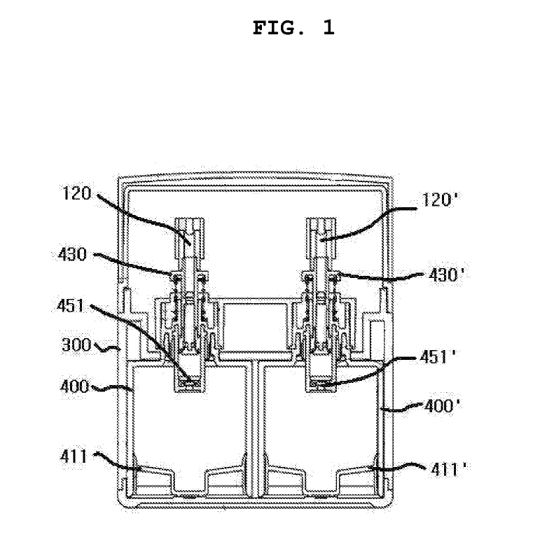

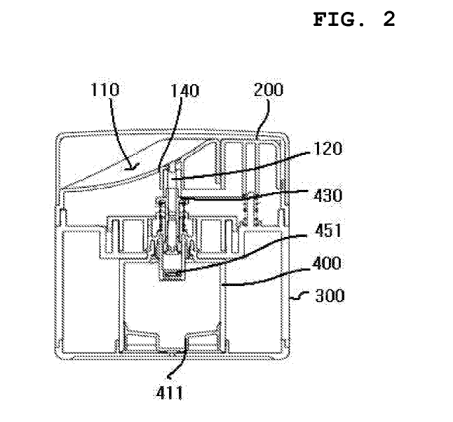

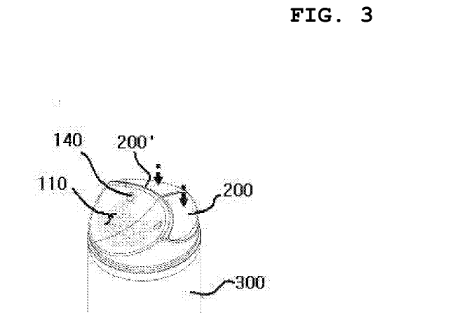

### BEST MODE

### Mode for Invention

Hereinafter, the detailed description will be made with reference to accompanying drawings.

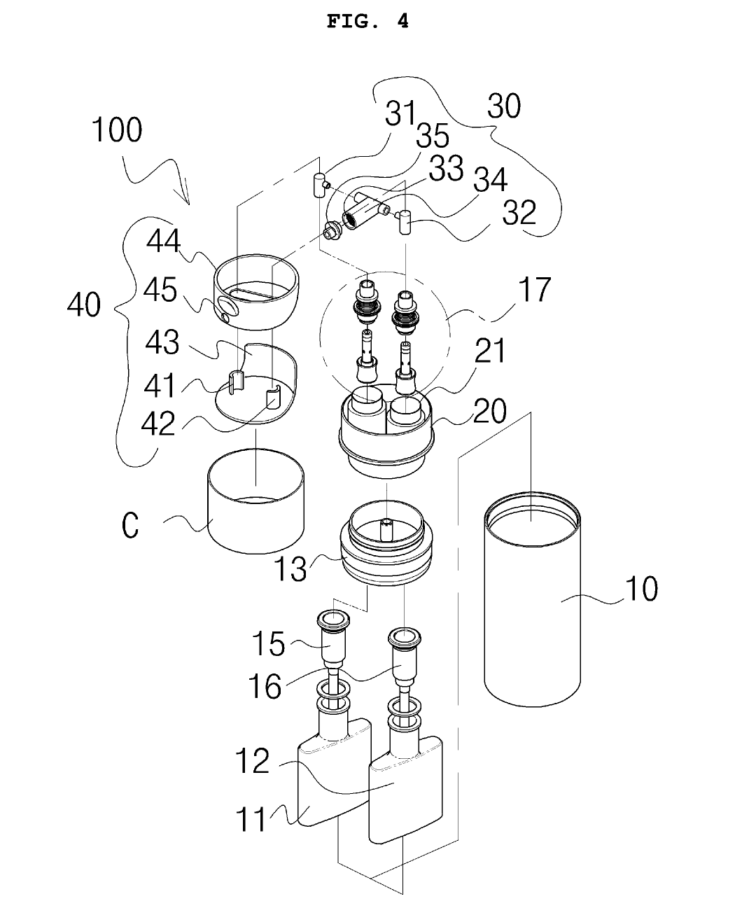

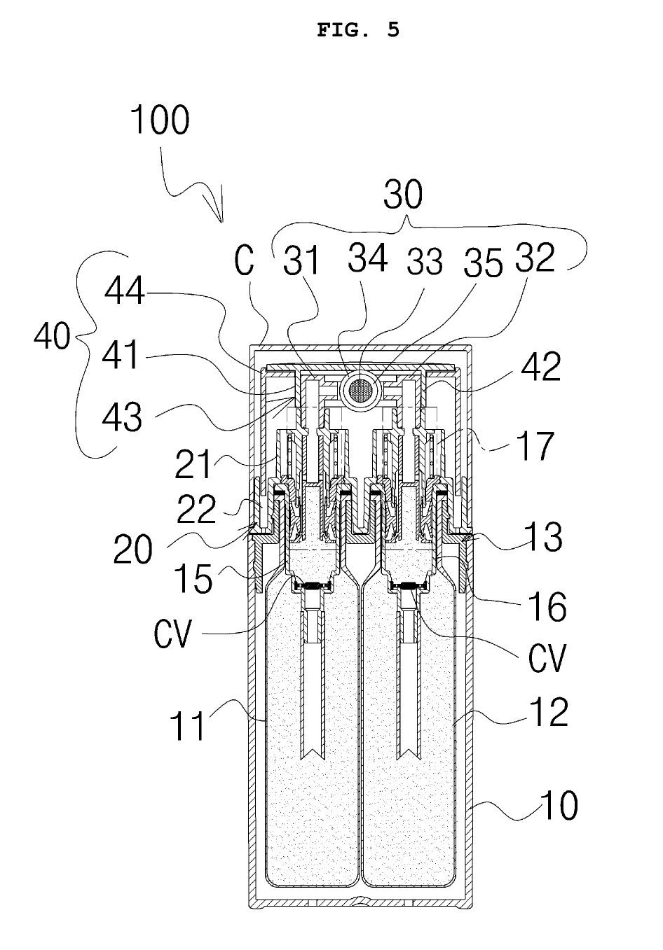

As shown in FIGS. 4 and 5, a cosmetic container 100 for mixing heterogeneous contents is provided on the bottom thereof with a container body 10 to receive a first storage container 11 and a second storage container 12 that separately store two types of cosmetic contents.

In this case, the first and second storage containers 11 and 12 include a soft film to be contracted as the cosmetic contents are consumed.

In addition, the film may correspond to one of polyethylene (PE), controlled polymer, and polypropylene (PP).

Openings of the first and second storage containers 11 and 12 are coupled to an inner peripheral portion of the container receiving part 13 which is undercut coupled to an inner peripheral portion of an opening of the container body 10, and first and second tubes 15 and 16 are provided inside the openings of the first and second storage containers 11 and 12 to receive check valves (CV), respectively.

The first and second tubes 15 and 16 are provided at the inner peripheral portions thereof with a pair of piston parts 17 moved up and down by external force.

The piston parts 17 are coupled to the first and second tubes 15 and 16 to constitute an airless pump that is generally known.

In addition, a shoulder part 20 undercut coupled to an outer peripheral portion of the container receiving part 13 includes a piston housing 21 to receive the piston part 17 and a pressing button sliding groove 22 spaced apart from the piston housing 21.

In addition, a mixing member 30 is provided at an upper end portion of the piston part 17 to mix the two types of cosmetic contents with each other. The mixing member 30 is provided at both sides thereof with first and second discharge passages (31 and 32), through which the two types of cosmetic contents are discharged. The mixing member 30 is provided in the center thereof with a single discharge passage 34 including a mixing inducing member 33 having pores that lower the high pressure when the cosmetic contents transferred through the first and second discharge passages 31 and 32 are mixed and discharged, and are formed to the extent that the path of the mixed cosmetic contents is not interrupted.

In this case, the mixing inducing member (33) may be formed of polyurethane foam, a sponge or loofah.

A discharge stopper 35 is coupled to an end portion of the single discharge passage 34.

A pressing button part 40 provided at an upper portion of the mixing in ember 30 includes a button cap 43 having first and second discharge passage housings 41 and 42 to receive the first and second discharge passages 31 and 32, and a button cap housing 44 to receive the hut tor cap 43 is formed in one side thereof with a discharge hole 45 to receive the discharge stepper 35.

The operation of the present invention configured as described is as follows.

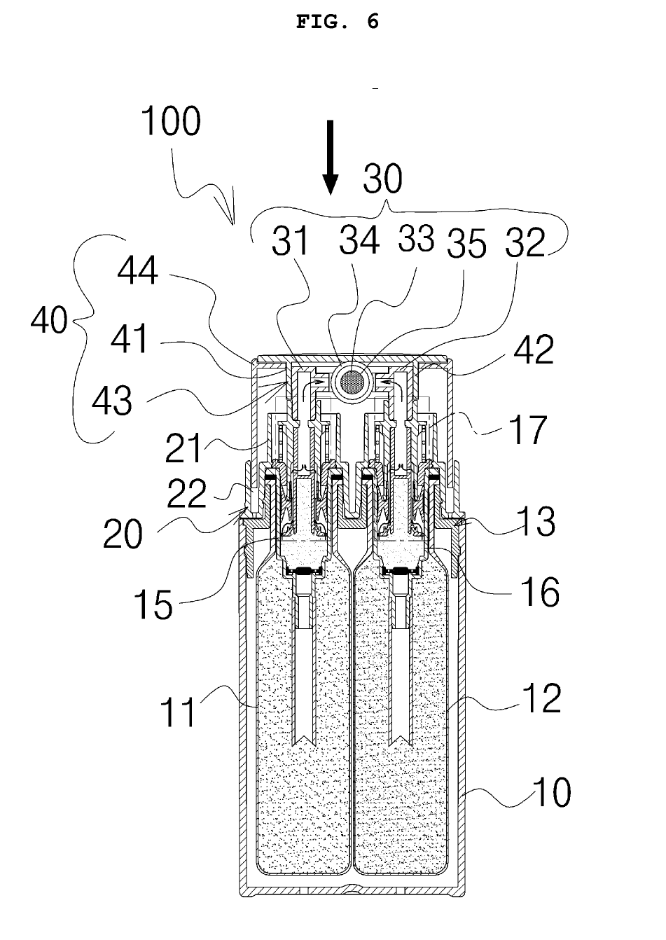

First, as shown in FIG. 6, if the button cap 43 of the pressing button part 40 is pressed down in the state that a cap C is open as shown in FIG. 6, the first and second discharge passages 31 and 32 of the mixing member 30 are moved down while the piston part 17 is moved down.

If the piston part 17 is moved down as described above, the internal spaces of the first and second tubes 15 and 16 are reduced due to the piston part 17. Simultaneously, the passages for the cosmetic contents are open, so that the cosmetic contents are discharged to the outside through the first and second discharge passages 31 and 32. If the pressure applied to the button cap 43 of the pressing button part 40 is released, the button cap 43 is moved down due to the elasticity of an elastic member. Simultaneously, the piston part 17 is moved up while vacuum pressure is generated in the first and second tubes 15 and 16. Accordingly, the check valves are open while the cosmetic contents in the first and second storage containers 11 and 12 are filled in the first and second tubes 15 and 16.

However, the discharged cosmetic contents flow through the first and second discharge passages 31 and 32, and pass through the mixing member 30 where the two types of cosmetic contents are collected.

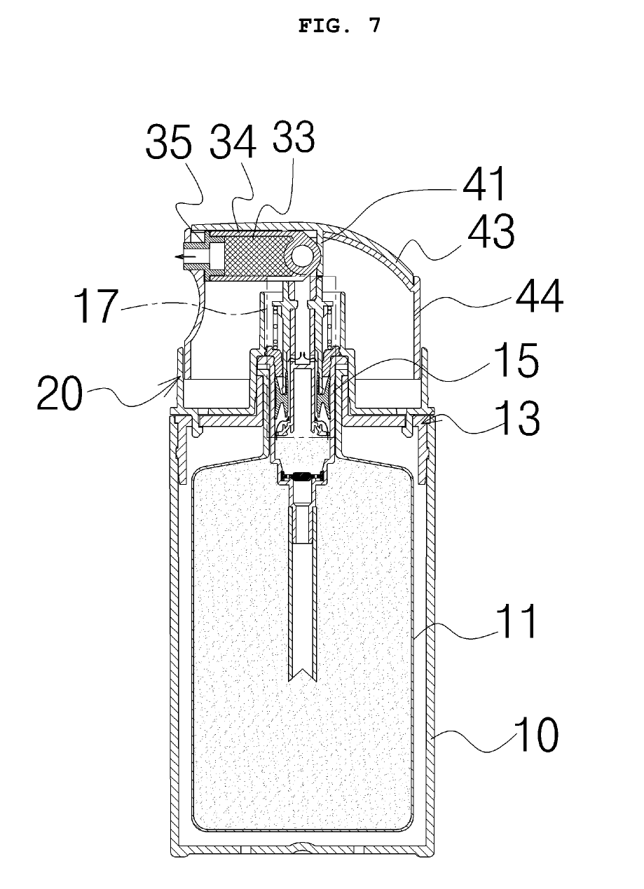

If the cosmetic contents are moved into the mixing member 30 as described above, the mixing inducing member 33 provided in the single discharge passage 34 mixes the two types of cosmetic contents as shown in FIG. 7.

In this case, the mixing inducing member 33 has the shape of a net sheet to low the high discharge pressure of the mixed cosmetic contents and to effectively mix the two types of cosmetic contents.

When the mixed cosmetic contents are discharged out of a discharge hole 45, the mixed cosmetic contents are discharged at lowered pressure without being directly discharged, so that the cosmetic contents can be prevented from being wasted or the periphery of the cosmetic container can be maintained in at clean state.

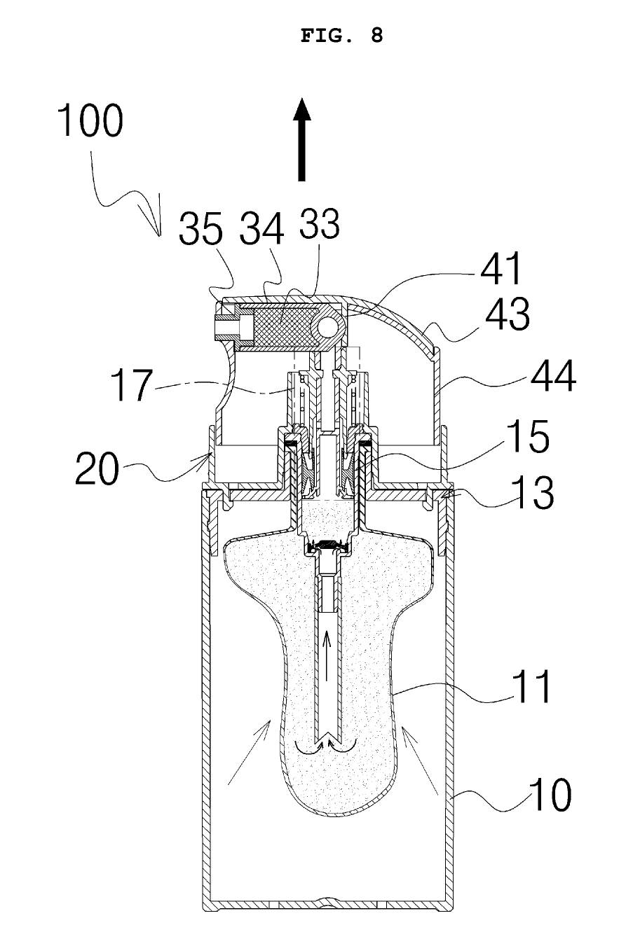

Meanwhile, as shown in FIG. 8 of accompanying drawings, the first and second storage containers 11 and 12 are contracted depending on an amount of consumed cosmetic contents.

The first and second storage containers 11 and 12 are preferably formed of a thin film material that can be easily contracted.

As described above, although an exemplary embodiment of the present invention has been described for the illustrative purpose, the present invent is not limited to the configuration and the operation thereof.

In addition, those skilled in the art can sufficiently understand that many modifications and variations of the present invention are possible without departing from the spirit and scope of the present invention as hereinafter claimed.

Accordingly, all preferable modifications and variations, and equivalents thereof should be considered to belong to the scope of the present invention.

1. A cosmetic container for mixing heterogeneous contents, the cosmetic container comprising:
a container body (10) to receive a first storage container (11) and a second storage container (12) that separately store two types of cosmetic contents;
a container receiving member (13) coupled to an inner peripheral portion of an opening of the container body (10) and coupled to outer peripheral portions of openings of the first and second storage containers (11 and 12);
first and second tubular containers (15 and 16) securely mounted in the openings of the first and second storage containers (11 and 12) to receive a piston part (17); and
a mixing member (30) provided at an upper end portion of the piston part (17) to mix the two types of cosmetic contents with each other,
wherein the mixing member (30) is provided therein with first said second discharge passages (31 and 32), through which the two types of cosmetic contents are transferred, and a single discharge passage (34) in which the two types of cosmetic contents are mixed with each other, and provided at an upper portion thereof with a pressing button part (40) to press the mixing member (30) and to release the pressing to the mixing member (30).

2. The cosmetic container of claim 1, wherein the first and second storage containers (11 and 12) include a soft film to be contracted as the cosmetic contents are consumed, and the film includes one of polyethylene (PE), controlled polymer, and polypropylene (PP).

3. The cosmetic container of claim 1, wherein the single discharge passage (34) is provided therein with a mixing inducing member (32) in which the two types of cosmetic contents transferred through the first and second discharge passages (31 and 32) are mixed with each other.

4. The cosmetic container of claim 3, wherein the mixing inducing member (33) includes polyurethane foam, a sponge or loofah.

5. The cosmetic container of claim 1, wherein the pressing button part (40) includes a button cap (43) having first and second discharge passage housings (41 and 42) to receive toe first and second discharge passages (31 and 32), and
a button cap housing (44), which receives the button cap (43) therein, is provided in one side thereof with a discharge hole (45) to receive a discharge stopper (35) provided in the single discharge passage (34).

6. The cosmetic container of claim 1, wherein the outer peripheral portion of the container receiving member (13) is coupled to a shoulder part (20) including a piston housing (21) to receive the piston part (17) and a pressing button sliding groove (22) spaced apart from the piston housing (21).
